(19) United States
(12) Patent Application Publication
(10) Pub. No.: US 2013/0255455 A1
(43) Pub. Date: Oct. 3, 2013

(54) HAIR CUTTING APPARATUS AND METHOD OF USE

(71) Applicant: Geoffrey McCue, Lawrence, KS (US)

(72) Inventor: Geoffrey McCue, Lawrence, KS (US)

(21) Appl. No.: 13/433,951

(22) Filed: Mar. 29, 2012

(51) Int. Cl. B26B 19/38; B26B 19/20; B26D 1/01; B26B 19/32

(52) U.S. Cl. 83/13; 30/228; 30/223; 30/43; 30/43.1

(57) ABSTRACT

The present inventive concept relates to a hair cutting apparatus and method of use for hair cutting, and in particular, to a hair cutting apparatus and method of use for hair cutting that enable a user to cut hair with improved ease and efficiency using palm-down movements. The hair cutting apparatus includes a housing, and the housing has an outer gripping surface shaped to receive a palm of the user for ergonomic use. Attached to the housing is a motor that drives a first shearing blade to move over a second shearing blade in a cutting action.

### BACKGROUND

1. Field

Embodiments of the present inventive concept relate to a hair cutting apparatus and method of use for hair cutting, and in particular, to a hair cutting apparatus and method of use for hair cutting that enable a user to cut hair with improved ease and efficiency using palm-down movements in various directions.

2. Discussion of Related Art

Clippers for cutting hair generally include a handle connected to a blade. Such handles are typically cylindrically-shaped to allow a user to manipulate the clipper and drag the clipper across a cutting surface. While dragging the blade across cutting surfaces using a conventional clipper, the user typically grasps the clipper while making a first oriented perpendicularly to the cutting surface, which results in an unnatural and difficult cutting movement for the user. Further, conventional clippers are limited to unidirectional cutting, and require removal from the cutting surface or readjustment within the user's hand to accommodate a change in cutting direction.

### SUMMARY

The following brief description is provided to indicate the nature of the subject matter disclosed herein. While certain aspects of the present inventive concept are described below, the summary is not intended to limit the scope of the present inventive concept. Embodiments of the present inventive concept provide an apparatus for cutting hair with greater ease and comfort, and a method of using the apparatus to these ends. The present inventive concept does not suffer from and remedies the deficiencies of conventional devices such as those previously set forth herein.

The present inventive concept provides, in its simplest form, a hair cutting apparatus configured to be held along a gripping surface for palm-down cutting. “Palm-down”, as used herein, means with the palm of the user generally facing a cutting surface. The hair cutting apparatus includes a housing, and the housing has an outer gripping surface shaped to receive a palm of the user for ergonomic use. Attached to the housing is a motor that drives a first shearing blade to move over a second shearing blade in a cutting action.

The aforementioned may be achieved in an aspect of the present inventive concept by providing a hair cutting apparatus having a housing. The housing has an outer surface which forms a gripping surface, and the gripping surface is preferably of a convex and ergonomic shape to receive a palm of the user. A motor is secured to the housing, and the motor is in operable contact with a first shearing blade. The motor drives movement, for example oscillation or rotation, of the first shearing blade over a second shearing blade which is attached to the housing.

The gripping surface may include an apex running generally along the center of the housing for improved grasping by the user. Grasp may further be improved where the housing includes a protrusion or knob extending from and adjacent to the gripping surface, and where the knob has an aperture or finger hole sized and shaped to at least partially receive a finger to facilitate secure gripping of the apparatus by one or more fingers of the user. The gripping surface may further include a surrounding surface of the finger hole for improved grasp.

The first and second shearing blades may each have two cutting edges for bidirectional cutting, a first and third cutting edge being on the first shearing blade and a second and fourth cutting edge being on the second shearing blade. The first cutting edge may then be moved over the second cutting edge in a cutting action, and the third cutting edge may be moved over the fourth cutting edge in a cutting action. The motor which drives the first shearing blade may in a preferred embodiment be a piezoelectric motor controlled by a microprocessor.

In another embodiment of the present inventive concept, a hair cutting apparatus is provided having a housing with an outer surface that presents a gripping surface. A base is attached to the housing, and a motor for driving a first shearing blade is attached to the base. A second shearing blade is also attached to the base, and the motor drives the first shearing blade to move over the second shearing blade for multi-directional cutting.

The hair cutting apparatus may further include a depth adjuster having clips to allow selective placement of the depth adjuster on the housing. This allows for additional adjustability of hair cutting length. Further, the first shearing blade may be driven by the motor via a motor gear connected to an output drive shaft of the motor and engaged with the first shearing blade at an internal circumference. The first shearing blade may be supported by supporting gears which also engage its internal circumference and are rotatably secured to the second shearing blade.

In still another embodiment of the present inventive concept, a method for palm-down cutting is presented. According to the method, a hair cutting apparatus is provided which has a gripping surface shaped to receive the user's palm. The hair cutting apparatus is applied to a cutting surface, and is moved across the cutting surface such that the user's palm remains generally facing the cutting surface. The user may also shave in more than one direction by employing preferred embodiments. For example, where the shearing blades each have two generally linear cutting edges facing opposing directions, the hair cutting apparatus may be utilized to cut hair by moving the hair cutting apparatus in either of the two opposing directions without the need to twist or reorient the housing of the hair cutting apparatus.

The multiple directions may include two opposite directions along a first linear path of the cutting surface, and/or two opposite directions along the first linear path of the cutting surface and a second linear path of the cutting surface. The second linear path may extend substantially perpendicular to the first linear path. The first shearing blade may mirror a configuration of the second shearing blade relative to the housing.

Additional aspects, advantages, and utilities of the present inventive concept will be set forth in part in the description which follows and, in part, will be obvious from the description, or may be learned by practice of the present inventive concept.

### BRIEF DESCRIPTION OF THE DRAWINGS

Embodiments of the present inventive concept are described in detail below with reference to the attached drawing figures, wherein:

FIG. 1 is a left side elevation view of a hair cutting apparatus of the present inventive concept;

FIG. 2 is an exploded view of the hair cutting apparatus illustrated in FIG. 1, including a piezoelectric motor and shearing blades having two substantially linear cutting edges;

FIG. 3 is an exploded view of a hair cutting apparatus of the present inventive concept, including an electric motor and shearing blades having one substantially circular cutting edge for multi-directional cutting;

FIG. 4a is a side view of a hair cutting apparatus of the present inventive concept, illustrating the hair cutting apparatus on a cutting surface and in the grasp of the user's hand; and

FIG. 4b is a front view of a hair cutting apparatus of the present inventive concept, illustrating the hair cutting apparatus on a cutting surface and in the grasp of the user's hand.

The drawing figures do not limit the present inventive concept to the specific examples disclosed and described herein. The drawings are not necessarily to scale, emphasis instead being placed upon clearly illustrating the principles of the present inventive concept.

### DETAILED DESCRIPTION

The following detailed description of the present inventive concept references the accompanying drawings that illustrate specific examples of the present inventive concept. The examples are intended to describe aspects of the present inventive concept in sufficient detail to enable those skilled in the art to practice the present inventive concept. Other combinations of, variations on, and relationships between the elements disclosed may be utilized without departing from the scope of the present inventive concept. The following detailed description is, therefore, not to be taken in a limiting sense. The scope of the present inventive concept is defined only by the appended claim, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

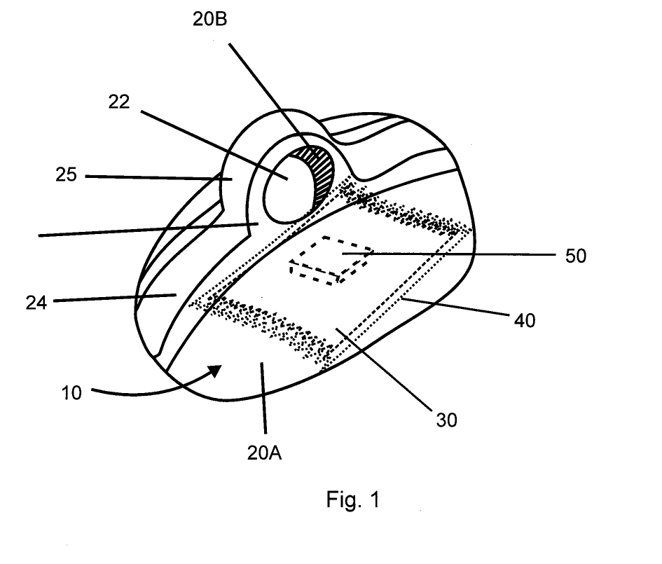

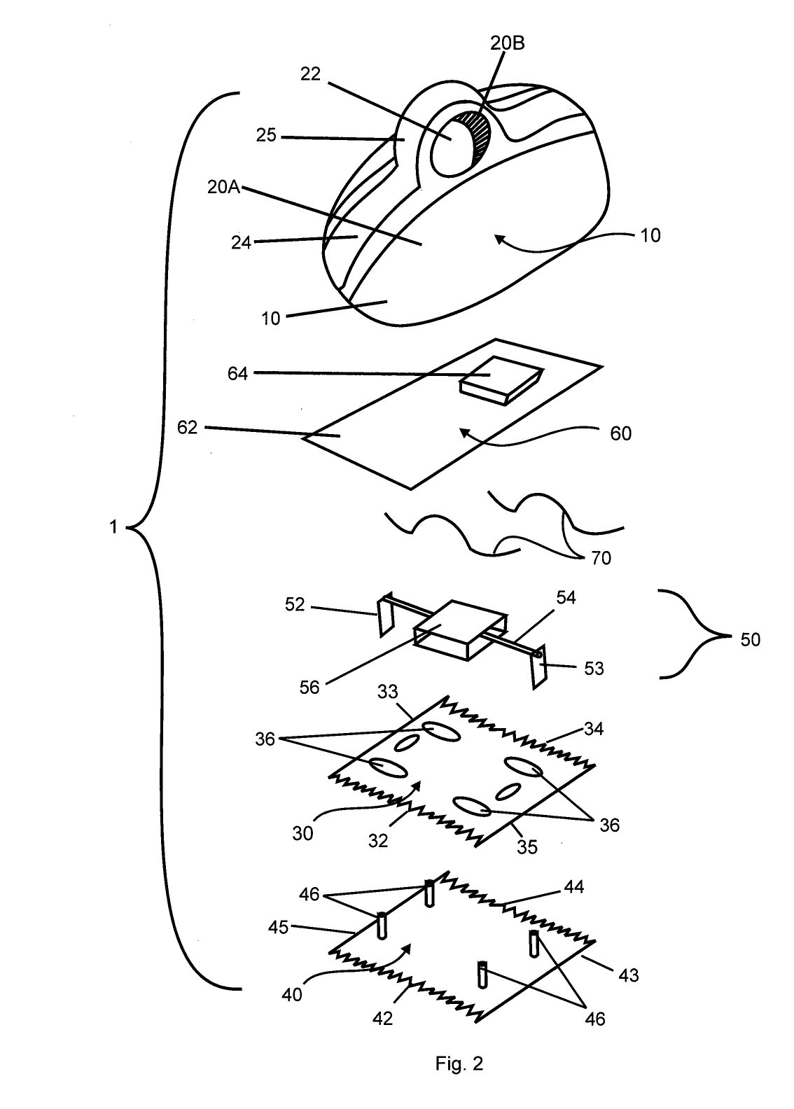

Turning to the drawings and particularly FIGS. 1 and 2, a hair cutting apparatus 1 is illustrated in assembled and exploded views, respectively. The hair cutting apparatus 1 generally includes a housing 10 having an outer gripping surface 20A, a motor 50, and first and second shearing blades 30, 40. The motor 50 is secured to the housing 10, and the motor 50 drives the first shearing blade 30 in a cutting action over the second shearing blade 40. The shearing blades 30, 40 are secured to the underside of the hair cutting apparatus 1 relative to the gripping surface 20A, which forms an elongated convex shape and extends substantially along an upward-facing surface of the housing 10.

To achieve an ergonomic and generally convex shape for ease of grasp by the user, the gripping surface 20A is shaped similarly to the exterior surface of a half-sphere, as illustrated in FIGS. 1 and 2, as the exterior surface of an elongated half-sphere. The gripping surface 20A has an apex 24 over which the fingers of a user may drape. The apex 24 generally runs along an imaginary line drawn perpendicular to the direction of insertion of a finger through a finger hole 22, and to separate a back half of the gripping surface 20A that is shaped substantially as the exterior surface of one quarter of an elongated sphere and that receives the palm of the user, and a similarly-shaped front half of the gripping surface 20A that receives the fingers of the user. The symmetry of the hair cutting apparatus 1 allows for reversible use of the front and back halves of the gripping surface 20A for receiving the palm and fingers of the user. In this manner, the finger hole 22 may receive a finger of the user from either direction without any change in operation of the hair cutting apparatus 1.

The apex 24 enables the user to apply pressure to the housing 10 to manipulate the hair cutting apparatus 1 during operation. The housing 10 also has a knob 25 protruding upward from the gripping surface 20A, the knob 25 being near a center of the gripping surface 20A. The finger hole 22 is sized and shaped to at least partially receive one of the fingers of the user through the finger hole 22, which extends at least partially and preferably entirely through the knob 25. The user may place one finger in the finger hole 22 through a side, or pinch the finger hole 22 with two or more fingers entering from both sides of the finger hole 22, to improve the user's grasp on the hair cutting apparatus 1. It is foreseen that the knob 25 may at varying positions on the hair cutting apparatus 1 and its housing 10, for example along the periphery or bottommost edge of the housing 10, without deviating from the spirit of the present inventive concept.

Referring now to FIG. 2, the hair cutting apparatus 1 is illustrated with a base 60, the base having a board 62 and a battery 64 mounted on the board 62 for powering the motor 50. The base 60 is secured to the housing 10 on the side opposite the gripping surface 20A. The second shearing blade 40 is secured to the base 60 by rigid or semi-rigid poles 46 which pass through the body of the first shearing blade 30 at slots 36. It is foreseen that the second shearing blade 40 may be secured to the housing 10 and/or base 60 in varying embodiments by different means, such as by poles of varying numerosity and shape which may or may not pass through the body of the first shearing blade 30, without deviating from the present inventive concept.

The first shearing blade 30 is positioned between the second shearing blade 40 and the base 60. During operation, the first shearing blade 30 of this embodiment is driven by the motor 50 having end flanges 52, 53 connected by a drive shaft 54 that traverses through a motor housing 56. When the motor 50 operates to move the drive shaft 54, the drive shaft oscillates and the end flanges 52, 53 push and/or pull respective sides 33, 35 of the first shearing blade 30 in opposite directions to generate an oscillating movement of the first shearing blade 30. The motor 50 of FIG. 2 is a piezoelectric motor powered by battery 64. It is foreseen that in alternative embodiments, the motor may constitute a standard electric direct current or alternating current motor, vertical or horizontal drive electric motor, magnetic drive motor, or other model of motor, and may drive movement of the first shearing blade via any of a variety of operable contacts and/or points of secured contact, without deviating from the spirit of the present inventive concept. The motor may also be powered by direct or alternating current delivered by cord without deviating from the spirit of the present inventive concept. It is further foreseen that the motor may be commanded by a microprocessor without deviating from the spirit of the present inventive concept.

The first shearing blade 30 is pressed against the second shearing blade 40 by tension springs 70 secured to the board 62 and extending downward toward the first shearing blade 30. The tension springs 70 may be adjusted to vary the amount of pressure placed on the first shearing blade 30 to press it against the second shearing blade 40, thus controlling the relative ability of the hair cutting apparatus 1 to cut difficult hair and the friction created by movement of the first shearing blade 30 over the second shearing blade 40.

The first shearing blade 30 of the embodiment of FIG. 2 has a generally linear and serrated first cutting edge 32. In operation, the first cutting edge 32 moves over a second cutting edge 42. The second cutting edge 42 is the corresponding cutting edge of the second shearing blade 40 and is also generally linear and serrated. As serrated teeth of the first cutting edge 32 move over serrated teeth of the second cutting edge 42, hair is caught between the teeth of the cutting edges 32, 42 and sheared or cut off. In a similar fashion, on the opposite side of the shearing blades 30, 40 are third and fourth cutting edges 34, 44. As serrated teeth of the third cutting edge 34 move over serrated teeth of the fourth cutting edge 44, hair is caught between the teeth of the cutting edges 34, 44 and sheared or cut off. The embodiment of FIG. 2 thus generally allows bidirectional cutting through side to side movement of the user's hand, such as a movement similar to moving the hand over the cutting surface in a palm-down chopping motion, with cutting substantially occurring at cutting edges which face the direction of movement. A hair cutting apparatus having a palm-down gripping surface is particularly well-suited for bi- or multi-directional cutting, at least because the user enjoys greater control over movement in more than one direction when the hand is in a palm-down orientation in comparison with the more awkward and haphazard perpendicular fist orientation required by existing devices.

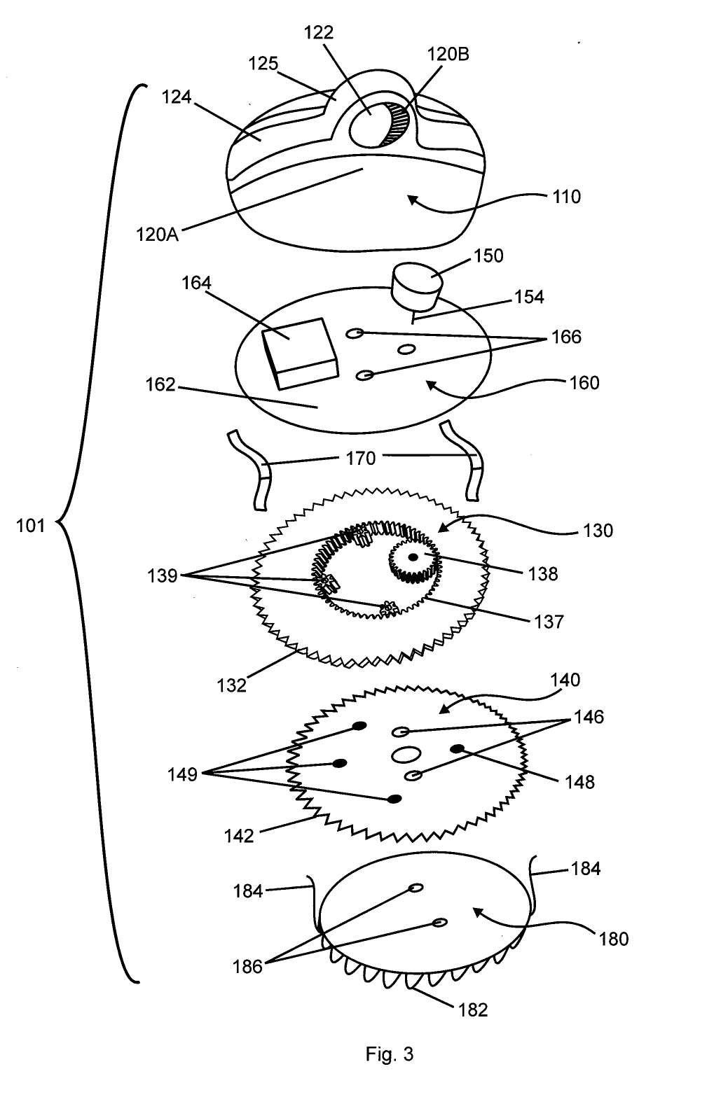

Referring now to FIG. 3, a hair cutting apparatus 101 is illustrated having a housing 110, the housing 110 has a gripping surface 120A, knob 125, finger hole 122 extending through tie knob 125, and an apex 124. A base 160 is secured to the housing 110, and a battery 164 and motor 150 are mounted on the base 160. The motor 150 drives a first shearing blade 130 over a second shearing blade 140. The first and second shearing blades 130, 140 are generally circular to permit movement of the hair cutting apparatus 101 to cut hair in any direction such as but not limited to four directions, e.g., two opposite directions along a first linear path of a cutting surface, and/or two opposite directions along the first linear path of the cutting surface and a second linear path of the cutting surface, the second linear path extending perpendicular to the first linear path, and/or in a circular motion, i.e., the hair cutting apparatus 101 is able to cut hair in all directions across a cutting surface while the user moves the hair cutting apparatus in a circular motion along it. The first shearing blade 130 has a first cutting edge 132 around its outer circumference, and the second shearing blade 140 has a second cutting edge 142 around its outer circumference.

The second shearing blade 140 is secured to the base 160 by securing means, such as rigid or semi-rigid poles, which are secured to the board 160 and which extend through the center of the first shearing blade 130 and are secured to the second shearing blade 140. It is foreseen that the second shearing blade may be secured to the housing and/or base in varying embodiments by different means, such as by poles of varying numerosity and shape which may or may not pass through the body of the first shearing blade, without deviating from the present inventive concept.

The first shearing blade 130 further comprises an internal circumference 137 having gear teeth facing the center of the first shearing blade 130. The first shearing blade 130 is driven by the motor 150 via a motor gear 138. The motor 150 drives rotation of a drive shaft 154, and the drive shaft 154 is secured to the motor gear 138. The motor gear 138 has gear teeth facing outward along the motor gear's 138 outer circumference, and the motor gear's 138 gear teeth engage the gear teeth of the internal circumference 137 to drive rotation of the first shearing blade 130.

Several support gears 139 are also in contact with the internal circumference 137 to minimize side to side movement of the first shearing blade 130 and maintain contact between the motor gear 138 and internal circumference 137. The support gears 139 have outward-facing gear teeth along their outer circumferences which engage the gear teeth of the internal circumference 137. The support gears 139 are rotatably mounted on rigid poles or other supporting means, and the supporting means are fixed to the second shearing blade 140. The three support gears 139 illustrated in FIG. 3 are positioned along the internal circumference 137 to form, in combination with the motor gear 138, two pairs of opposing gears which secure the first shearing blade 130 against side to side movement.

Two tension springs 170 press the first shearing blade 130 toward the second shearing blade 140. The tension springs 170 are fixed to the board 162, and extend downward to contact the first shearing blade 130 between the first cutting edge 132 and internal circumference 137. The embodiment of FIG. 3 also includes a depth adjuster 180. The depth adjuster 180 has rigid or semi-rigid clips 184 which extend generally toward the housing 110. The depth adjuster 180 is selectively clipped to the housing 110 to achieve different cutting lengths. Adjusting the depth adjuster 180 higher on the housing 110 will bring it closer to the second shearing blade 140 for shorter hair cutting. The depth adjuster 180 may be selectively placed lower on the housing 110 using the clips 184 for longer hair cutting. The depth adjuster 180 is buffered from the cutting surface using separators 182, which may be a series of parallel flanges or a number of bristles having substantially the same length. Length of cutting may thus also be adjusted by adjusting the length of the separators 182.

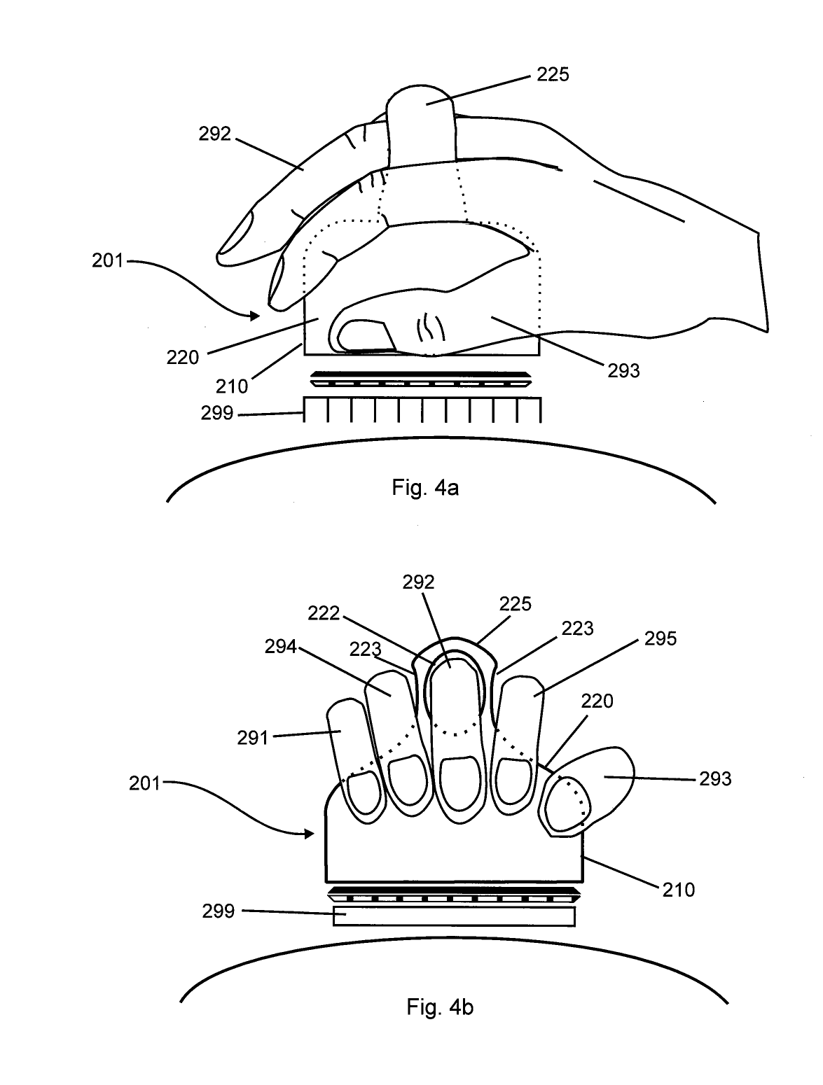

Referring to FIG. 4b, a hair cutting apparatus 201 having a gripping surface 220 is illustrated with the user's thumb 293 curled around the right side (according to this frontal view) of the gripping surface 220. A middle finger 292 is inserted through a finger hole 222 extending through a knob 225 of the housing 210; the middle finger 292 rests at its terminus on the gripping surface 220. A pinky finger 291 rests on the left side of the gripping surface 220. Index and ring fingers 295, 294 rest in indentations 223 in the knob 225. The indentations 223 provide a comfortable resting place for the index and ring fingers 295, 294 by reducing the effective width of the knob 225. The hair cutting apparatus 201 allows for palm-down cutting for more natural cutting movements. It is foreseen that the hair cutting apparatus may be operated using left or right hands without departing from the scope of the present inventive concept.

Referring now to FIG. 3, the user may lightly squeeze the gripping surface 120A with thumb, index, ring and pinky fingers, and have his middle finger comfortably threaded through the finger hole 122 and also resting on the gripping surface 120A at the middle finger's terminus. The hair cutting apparatus 101 may then be moved across a cutting surface for hair cutting in multiple directions without the need to remove the hair cutting apparatus 101 from the cutting surface or reposition it within the user's hand. The user's hand is thus positioned, during cutting, substantially parallel to the first and second shearing blades 130, 140, as well as the cutting surface.

The hair cutting apparatus 101 may, of course, be easily removed from the cutting surface by lifting along the z-axis in the positive direction and/or by utilizing the finger hole 122. The gripping surface may further include a surrounding surface 120B of the cavity of the knob 125. The surrounding surface 120B allows greater versatility of physical manipulation by the user, because the user may place a finger through the finger hole 122 and place pressure on the surrounding surface 120B to, for example, lift the hair cutting apparatus 101 from the cutting surface with reduced squeezing pressure on the gripping surface 120A.

These and other uses of, and modifications to, the present inventive concept will be apparent to those of skill in the art upon reading this disclosure. For example, it is foreseen that the shearing blades may include more than two cutting edges, and the hair cutting apparatus 1 may be configured to cut hair in more than two directions, without deviating from the present inventive concept.

Having now described the features, discoveries, and principles of the present inventive concept, the manner in which the present inventive concept is constructed and used, the characteristics of the construction, and advantageous, new and useful results obtained; the new and useful structures, devices, elements, arrangements, parts and combinations, are set forth in the appended clams.

It is also to be understood that the following claims are intended to cover all of the generic and specific features of the present inventive concept herein described, and all statements of the scope of the present inventive concept which, as a matter of language, might be said to fall there between.

What is claimed is:

1. A hair cutting apparatus having a gripping surface to permit palm-down cutting, the hair cutting apparatus comprising:
a housing including the gripping surface, the gripping surface having a convex ergonomic shape to receive a palm of a user;
a motor secured to the housing, the motor in operable contact with a first shearing blade to drive movement of the first shearing blade over a second shearing blade, and
wherein,
the second shearing blade is attached to the housing, and
the first shearing blade is in slidable contact with the second shearing blade.

2. The hair cutting apparatus of claim 1, wherein the gripping surface includes an apex substantially along the center of the housing.

3. The hair cutting apparatus of claim 1, wherein the housing includes a cavity extending at least partially through the housing, the cavity defining a finger hole operable to receive at least a portion of a finger therein for grasping the hair cutting apparatus.

4. The hair cutting apparatus of claim 1, wherein the gripping surface includes a finger hole operable to receive a finger from either direction through the finger hole without changing performance of the hair cutting apparatus.

5. The hair cutting apparatus of claim 1, wherein,
the first shearing blade includes a first cutting edge, and
the second shearing blade includes a second cutting edge.

6. The hair cutting apparatus of claim 5, wherein,
the first shearing blade includes a third cutting edge,
the second shearing blade includes a fourth cutting edge,
the first cutting edge is operable to move over the second cutting edge, and
the third cutting edge is operable to move over the fourth cutting edge.

7. The hair cutting apparatus of claim 6, wherein the motor is a piezoelectric motor.

8. A hair cutting apparatus for multi-directional shaving, the hair cutting apparatus comprising:
a housing having an outer surface that presents a gripping surface having a convex ergonomic shape to receive a palm of a user;
a base attached to the housing;
a motor secured to the base, the motor operably attached to a first shearing blade to drive movement of the first shearing blade over a second shearing blade;
wherein the second shearing blade is attached to the base, and
wherein the first shearing blade is in slidable contact with the second shearing blade.

9. The hair cutting apparatus of claim 8, wherein,
the first shearing blade has a first cutting edge,
the second shearing blade has a second cutting edge, and
the motor is operable to drive the first cutting edge over the second cutting edge.

10. The apparatus of claim 8, wherein the housing includes a knob having a cavity extending at least partially through the knob to define a finger hole.

11. The hair cutting apparatus of claim 10, wherein the gripping surface includes a surrounding surface of the finger hole.

12. The hair cutting apparatus of claim 8, wherein the motor is an electric motor.

13. The hair cutting apparatus of claim 8, further comprising:
a depth adjuster having clips to permit selective spacing adjustment along a height of the hair cutting apparatus for adjusting the length of hair cutting.

14. The hair cutting apparatus of claim 8, wherein,
the first shearing blade includes an internal circumference having gear teeth facing the center of the first shearing blade, and
the motor drives the first shearing blade via a motor gear engaged with the gear teeth of the internal circumference.

15. The hair cutting apparatus of claim 14, further comprising:
a plurality of support gears spaced from each other along the internal circumference, the support gears in contact with the internal circumference at outward facing gear teeth of the support gears.

16. The hair cutting apparatus of claim 15, wherein the support gears are rotatably mounted to poles, and the poles are fixed to the second shearing blade.

17. A method for palm-down cutting, the method comprising:
providing a hair cutting apparatus having a gripping surface shaped to receive a user's palm;
applying the hair cutting apparatus to a cutting surface; and
executing a first movement of the user's palm such that the hair cutting apparatus translates across the cutting surface and the user's palm remains generally facing the cutting surface.

18. The method of claim 17, wherein the hair cutting apparatus is configured to cut hair attached to the cutting surface by moving over the cutting surface in multiple directions.

19. The method of claim 18, wherein the multiple directions include one of (i) two opposite directions along a first linear path of the cutting surface, and (ii) two opposite directions along the first linear path of the cutting surface and a second linear path of the cutting surface, the second linear path extending perpendicular to the first linear path.

20. The method of claim 17, wherein the first shearing blade mirrors a configuration of the second shearing blade relative to the housing.
